(19) United States
(12) Patent Application Publication
(10) Pub. No.: US 2004/0225555 A1
(43) Pub. Date: Nov. 11, 2004

(54) System and method for generating targeted marketing resources and market performance data

(76) Inventors: Andreas Persidis, Athens (GR); Aris Persidis, Charlottesville, VA (US)

Correspondence Address: MORGAN & FINNEGAN, L.L.P., 3 WORLD FINANCIAL CENTER, NEW YORK, NY, 10281-2101, US

(21) Appl. No.: 10/435,105

(22) Filed: May 9, 2003

(51) Int. Cl. G06F 17/60

(52) U.S. Cl. 705/10

(57) ABSTRACT

A computer-based system and method for processing publications and recording industry-specific information, people and contact information contained in the publication. Taking the recorded information and storing it in a relational database. A query process creates highly targeted and personalized marketing resources or market performance data from the database. A Query Expansion process further allows the linking of people with an augmented set of concepts by following, within the taxonomies and ontologies, the hierarchical and other relationships of the work-related activities, interests and products that are documented in the publication.

### FIELD OF THE INVENTION

This invention relates generally to the generation of targeted industry-specific information databases through the analysis of publications and using the created databases to create marketing and market performance materials. More particularly, it relates to a method for identifying activity-specific concepts within publications, correlating them in a manner that is valid within that field of activity and further linking them with people companies and products that are mentioned in that publication and also in large collections of publications.

### BACKGROUND OF THE INVENTION

In today's business environment a person's time and attention span are both at a premium. Marketing and sales executives generally face the problem of obtaining accurate information about the purchase patterns and interests of current and potential customers. This information could be usefully employed in identifying new customers as well as in proposing new products/services to existing customers that are more accurately targeted to the true needs of these prospects. Analyzed over large numbers of consumers, this data could also provide insight into market trends and could serve in the design of new products and services.

Existing methods aim to create a consumer profile where the user is identifiable and his purchasing or online behavioral patterns can be tracked. While this scenario covers a large population of consumers, it does not address situations where the final end user is not known or where the work-related needs of this user are not known. For example, suppliers of chemical and biological reagents, instruments and other laboratory supplies are generally unable to obtain accurate information about the purchase patterns, current work needs and interests of the end users of their products.

In the scenario described above, the true user of the product is usually not known to the seller because of centralized purchasing practices. For example, in most university and large corporate research laboratories researchers prepare a purchase request that is processed by the lab manager or the procurement officer. The lab manager will in turn place orders in batches and will dispatch them to the appropriate recipient when the items arrive. This process severs the link between the primary stakeholders of the transaction resulting in sub-optimal practices for both parties.

Accordingly, marketers must resort to costly, inefficient and ineffective methods of communicating with their potential clients. Traditionally, marketing materials must be distributed via mass mailings targeting the broadest possible swath of potential customers. This process results in a notoriously low rate of return. Potential customers are inundated by irrelevant mailings and are unlikely to sort their junk mail to discover the few relevant items they might receive. Similarly, suppliers do not have accurate knowledge regarding who their customers are or what their needs might be.

A related problem exists in obtaining market performance data. Generally, coarse-grained public financial data is used to determine the market success of a product relative to others in the industry. The problem of discovering who is using a competitor's product is essentially the same as determining who is using your product. Of course, it can only be more difficult to accurately determine who your competitors' customers are. This difficulty directly affects the ability to obtain accurate relative performance data of a given product.

### SUMMARY OF THE INVENTION

A technical advance in the art is achieved by providing a system and method to identify the activities, interests and purchase decisions of consumers and to use this information to create and maintain highly targeted mailing lists and performance data that can be used by suppliers as part of their marketing campaign.

An object of the present invention is to create a Co-Occurrence Database. The Co-Occurrence Database contains relevant industry-specific information that has been extracted from publications related to the industry in question. The database also contains records of people that appear in the publication and their contact information. By identifying people and industry-specific topics presented in articles in which their names appear the Co-Occurrence Database provides highly relevant information.

A further object of the present invention is to provide a method for creating highly targeted—industry-specific—mailing lists based on documented activities, interests and purchase decisions of consumers as well as on projections of these derived from industry-specific knowledge represented as a list, taxonomy or ontology of concepts specific to the industry.

A further object of the present invention is to use query expansion to derive additional links between topics searched and related topics not specifically identified by the query. This expansion is derived from taxonomies and ontologies that describe the specific industry.

A still further object of the present invention is to provide relevant market performance analyses. This information is generated through targeted queries of a Co-Occurrence Database.

The above and other features of the present invention are described in more detail with reference to the following drawings annexed hereto.

### BRIEF DESCRIPTION OF THE DRAWINGS

FIG. 1 is a block diagram demonstrating an overview of an exemplary embodiment of the present invention.

FIG. 2 is a block diagram showing an exemplary embodiment of a World Model according to the present invention.

FIG. 3 is a block diagram showing an exemplary embodiment of the Instance Identification Process and shows the inputs and output of the process.

FIG. 4 is a block diagram showing an exemplary embodiment of the structure of different domain-specific resources.

FIG. 5 is a block diagram showing an exemplary embodiment of a table used to format the Co-Occurrence Records.

FIG. 6 is a block diagram showing an exemplary embodiment of the Query Process.

FIG. 7 is a block diagram showing an exemplary embodiment of the Query Expansion Process inserted into the Query Process.

FIG. 8 is a more detailed diagram showing an exemplary embodiment of Query Expansion Process.

FIG. 9 is a diagram showing an exemplary embodiment of a process for providing market performance data.

### DETAILED DESCRIPTION OF THE INVENTION

In the following description of the various embodiments, reference is made to the accompanying drawings which form a part hereof, and in which are shown by way of illustration various embodiments in which the invention may be practiced. It is to be understood that other embodiments may be utilized and structural and functional modifications may be made without departing from the scope of the present invention.

The present invention provides a system and method for generating a database containing detailed information regarding a particular industry. It does so by recognizing that voluminous and detailed information regarding an industry is provided in publicly available documents produced by the industry. These materials include research articles, patents, promotional brochures, web pages, press releases, conference announcements, etc. Using this source material, a database can be compiled and organized into a valuable set of easily accessible information. The information in this database can then be queried to generate informative industry-specific materials. For example, a user of the database could generate a mailing list detailing researchers using a particular material or a market performance analysis detailing how sales of one product performs relative to its peers.

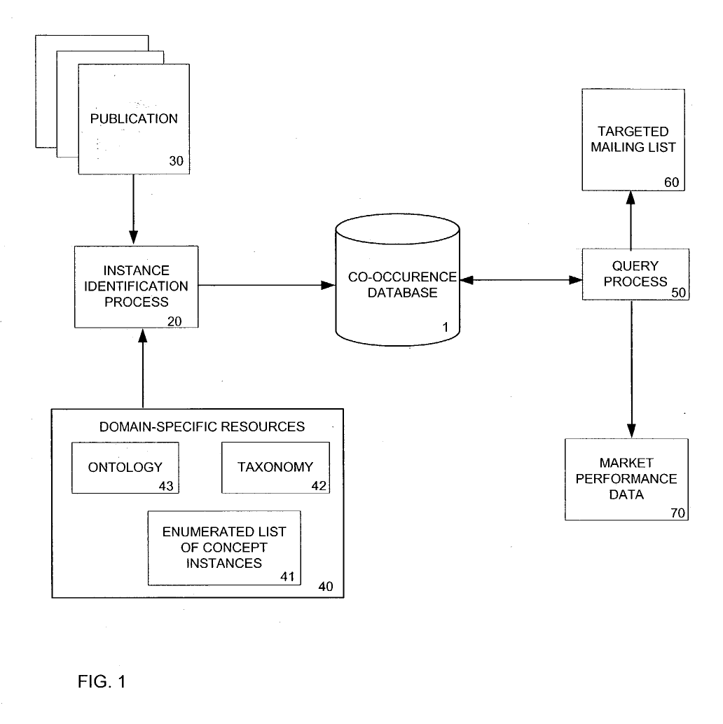

An exemplary embodiment of the present invention is depicted in FIG. 1, which shows a block diagram overview demonstrating the interrelation of particular elements of the embodiment. The left side of FIG. 1 depicts the processing of industry-specific information to generate a Co-Occurrence Database 1. Generally, the Co-Occurrence Database is generated using an Instance Identification Process (“IIP”) 20. The IIP 20 is a method that processes Publications 30 to derive entries recorded in the Co-Occurrence Database. In addition to the publications, the IIP is input with Domain-Specific Resources 40, which are industry-specific materials used by the IIP to identify relevant information contained in the processed publications.

The right side of FIG. 1 depicts the process of deriving useful industry-specific information from the Co-Occurrence Database. The Query Process 50 represents a method that searches the Co-Occurrence Database 1 and generates detailed reports, such as, Targeted Mailing Lists 60 or Market Performance Data 70.

The system shown in FIG. 1 can be implemented using well known computer hardware and software programming techniques. The Publications 30, Domain Specific Resources 40, Targeted Mailing Lists 60 and Market Performance Data 70 will be embodied by digital files residing in a computer memory. The IIP 20 and Query Process 50 are embodied in software algorithms programmed to carry out the disclosed methods. These programs are run on computers in the typical fashion. Finally, the Co-Occurrence Database 1 represents a relational database stored in computer memory.

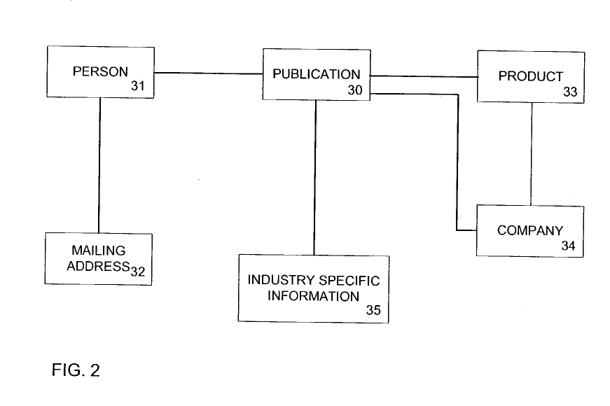

FIG. 2 shows a World Model of an exemplary embodiment of the present invention. The World Model represents the interrelation of the relevant concepts used in a particular implementation of the present invention. In this particular example, the primary source of information feeding the system is the Publication 30. As can be seen in this model, there is no direct connection between, for example, people and industry-specific information, except through their Co-Occurrence in a given publication, whereas people and addresses and products and companies are linked without reference to the specific publication.

The publication 30 is used as the root source of information that correlates people and products or companies, people and industry-specific information, and industry-specific information and products or companies. Publications are used because they contain information that links participants of an industry with specific areas of activity, tasks and products that can be used to enhance the relationship between producers and users of products and services that are relevant to that industry. In other words, specific instances of the previous concepts are deemed related if they appear together in an analyzed publication.

Publications can be press releases, scientific articles or conference announcements, which are readily available in electronic format and can be found in a variety of distribution channels such as the world-wide-web (WWW), CDs, etc. Each publication, for example a single scientific article, is treated as a single information-carrying unit.

Person 31, represents researchers or other individuals that are mentioned in publications, as authors or otherwise. Of course, a single person might appear in any number of publications or a publication might mention several people. People should have one or more associated Mailing Addresses 32. In many instances the person's address will be derived from contact information contained in the publication. Mailing Address 32 is linked to Person rather than directly to Publication to indicate that the address is only relevant because it is linked to a specific person. In other words, an address will never appear in an article without linking it to a specific person, while a person might appear without an associated address.

Companies 33 and Products 34 are self explanatory. For biotechnology, examples of products would be biological and chemical reagents, laboratory equipment, etc, and examples of companies include laboratory supplies, equipment and service providing companies. They are logically treated similar to people and addresses, in that they are found in publications and are related to one another. Companies and Products, however, might each appear individually in an article so they are both directly connected to the publication. The relation between companies and products, also, demonstrates a narrower relationship that could be employed. For example, in this particular embodiment a company can have multiple products but a product can only be related to one company. This approach is useful in industries where products are referred to using brand names and are therefore unique to a particular company.

Finally, Industry-specific Information 35 is found in publications and relates to the specific industry and topics considered by the particular implementation. It represents lexical resources, i.e. terms denoting concepts that are relevant to a specific industry. Examples of relevant concepts in the biotechnology and pharmaceutical industry would be genes, diseases, biological pathways, laboratory methods and procedures, model organisms, drug names, etc.

To summarize the exemplary World Model of FIG. 2, a publication is the source from which the relationships between the remaining main elements are derived. A publication can contain many People, Addresses, Industry-specific Information, Products and Companies. Conversely, an Address, Person, Industry-specific Information, Product and Company can appear in many publications. Finally, a Company can have many Products but a Product can only belong to a single Company. The above structure provides the flexibility that is required to capture the multitude of links that exist between these concepts.

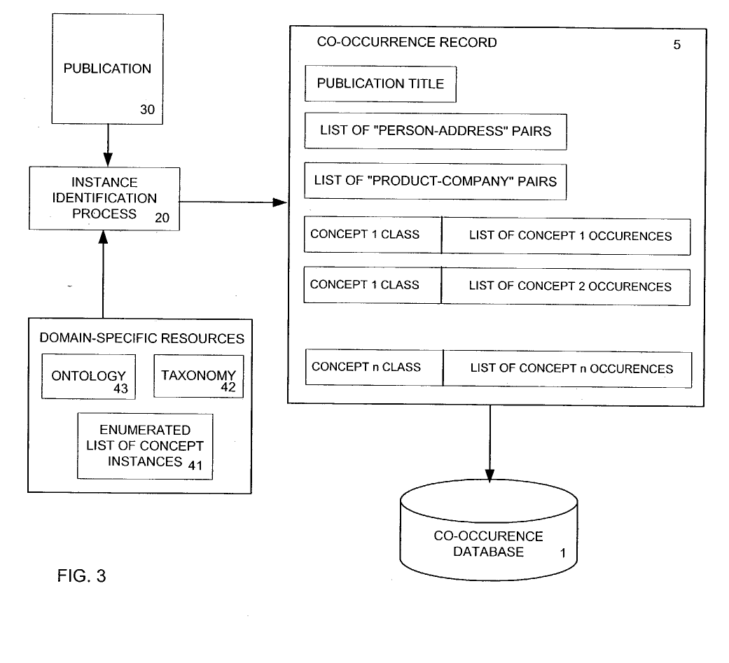

FIG. 3 shows the Instance Identification Process (IIP) 20 in detail. The IIP takes as input a set of publications 30 and processes each one individually. For each publication it produces a Co-Occurrence Record 5, which in turn is stored in the Co-Occurrence Database 1. The IIP runs iteratively as long as an unprocessed publication remains in the given input set of publications.

The set of Domain Specific Resources 40 are lexical resources consisting of one or more enumerated lists 41, taxonomies 42 or ontologies 43 of concepts that are deemed by the user of the present invention relevant to the domain of application. The Domain Specific Resources are used to identify relevant topics expected to be found in the processed publications. The Domain Specific Resources can contain information relating to any of the concepts identified in the World Model. In this particular embodiment, Domain Specific Resources are provided for Industry-Specific Information, Products and Companies.

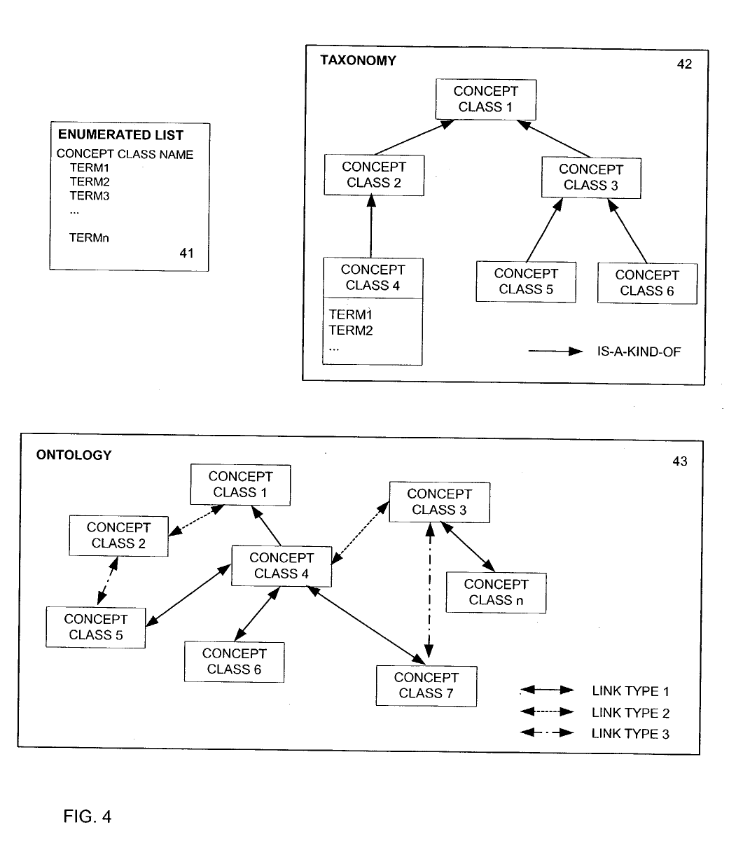

FIG. 4 shows different available formats for Domain Specific Resources and the main differences between them. An enumerated list of concepts 41 is the simplest form of Domain Specific Resource. It is merely a list of relevant topics formatted to distinguish between individual elements of the list, e.g. a list of companies. For example, an enumerated list of concepts in the field of biology for could consist of the names of all the human genes. The list can be formatted such that each gene is represented by a word and separated from the next gene by a comma within a linear sequence of words and saved in a text file. This structure enables the list to be easily processed by computer programs practicing the disclosed system. The list has the particular advantage of being simple to describe and design.

A taxonomy 42 is like an enumerated list only it represents a class-subclass relationship between concepts. This would indicate that members of the subclass are a kind of object defined by the class. For example, diseases could be arranged in a taxonomy where ‘cancer’ would be a class and ‘colon cancer’, ‘breast cancer’ and ‘lung cancer’ would be its subclasses. Furthermore, subclasses could have further subclasses. A taxonomy can be represented in a variety of ways, one of which would be to follow each class by a list of all its subclasses, where the list contains terms arranged in a linear sequence that is enclosed within a left and right parenthesis.

An ontology 43 is more sophisticated than a taxonomy because it can represent any relationship between concepts. An ontology, therefore, can represent relationships beyond class-subclass. For example, an ontology could indicate that two concepts are substitutes for one another. This relationship could then be used to link two products to show product A is a substitute for product B. FIG. 4 represents this flexibility by generically referring to the relationships shown as Link 1, Link 2 and Link 3. This demonstrates that determining the relationships described is a task left to a particular embodiment for a particular industry.

Returning to FIG. 3, for each publication the IIP works as follows. The IIP begins by selecting the first resource in the set, for example a list of disease names. For each of these disease names it searches the publication for a matching term. In practice these functions might be run in parallel in a particular computer environment. If it finds that term, the IIP adds the name of the disease to the Co-Occurrence Record 5 of the publication. The HiP repeats this step for each resource in the set. At the end of this process the Co-Occurrence Record contains the instances of all the concepts in the lexical resources that appear in the publication.

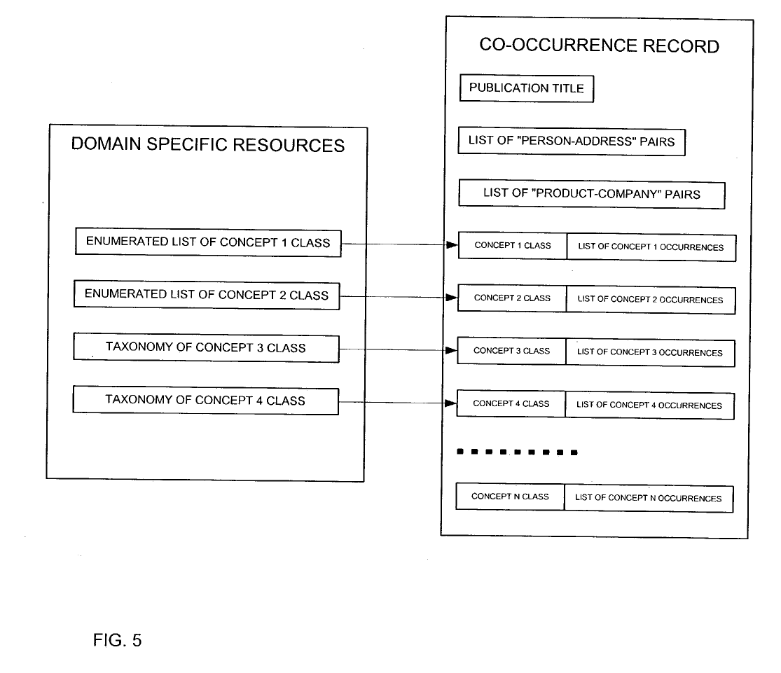

Each term is added only once in the Co-Occurrence Record and is added as an occurrence of its respective concept class. These concept classes represent fields of the Co-Occurrence Database. For example, if the term ‘colon cancer’ is found in the publication, it is added as a value in the field “Diseases”. To perform this step the IIP maintains a table that links each lexical resource classes (e.g. an enumerated list of diseases) with a unique field (e.g. “diseases”) of the Co-Occurrence Record as shown in FIG. 5. This information could also be described by a taxonomy or ontology, where each element of the taxonomy or ontology has an analogous field in the Co-Occurrence Database.

The identification of people and addresses could in principle be implemented in the manner described above, for example by using a list of names and addresses derived from a less targeted mailing list. In practice, however, software performance considerations may dictate a solution that uses additional knowledge to perform this step because a long list of names would require an excessive number of iterations of the IIP process.

Another approach would be to identify names using the formatting contained in the publication itself. For example, in scientific articles it is possible to take advantage of the predictable layout of some information, such as author names and addresses, to identify these without maintaining an enumerated list of all possible person names and addresses. To implement this different algorithms may be needed for various publications because different journals might use different organizational schemes.

Another approach would take advantage of the emergence of XML (Extensible Mark-up Language). XML makes this process straightforward because it allows publishers to tag some information such as author names, article references etc. within the electronic document. These tags, which clearly identify the required concept within the publication, can then be used to recover directly the required data.

A more sophisticated approach would employ Natural Language Processing (NLP). Natural Language Processing technologies, for example, identify people, organization names and addresses without making use of tags or enumerated lists, but rather by using knowledge of writing conventions (e.g. proper names are capitalized, company names are usually followed by Inc. or Co. etc.), syntax and grammar.

Identifying people and addresses in isolation is the first step. Next, each person must be linked to their address. Once again this linking can be performed either using some NLP method or knowledge of the layout of the publication. For example scientific articles link authors with their respective organization using superscripts or subscripts of some kind, which can be easily traced by a computer method to identify this link.

Employing a non-technical solution, identification of people and their associated address could be accomplished using human data entry workers. In this scenario a person could be inserted in the IIP process to carry out the identification and linking functions.

Depending on the size of a given market, the methods described for people and addresses can also be used for products and companies. In larger industries it might be advantageous to use the methods described for people, such as Natural Language Processing. Or, knowledge of reporting conventions can be employed to make this link just as described for the link between people and their address. For example, scientific articles often report the usage of a biological reagent by first mentioning the name of the product and immediately following this by the name of the supplying company enclosed in parenthesis. As another example, the “materials and methods” section of scientific articles in the biology and pharmaceutical industry describes the work carried out by scientists in terms of chemical and biological reagents and their suppliers.

In a small market, however, companies and products could be identified by generating Domain Specific Resources. A taxonomy or ontology, for example, would be ideal for linking companies and products.

Once a Co-Occurrence Record 5 is generated by the UP it is added to the Co-Occurrence Database 1, as shown in FIG. 3. Given a set of publications, the IIP processes each one individually, creating a unique record, which it adds to the Co-Occurrence Database. Of course, publications could be processed in parallel on one computer or multiple computers. The IIP terminates once all the publications in the input set are processed. Note that the IIP can be run whenever a new set of unprocessed publications is available and that there is no fixed requirement in terms of the number of publications within each set or the time at which the process will be run.

The Co-Occurrence Database generated by the process described above provides a wealth of information through its ordering of previously unordered data appearing in the publications. The data in the Co-Occurrence Database is particularly advantageous because it allows the identification of consumer interests and product usage that is based on work-related activities that are documented by the consumers themselves. Moreover this information, which may be informative of a person's undocumented interests, is captured passively with no additional effort required on the part of that person. This wealth of collected data can then be queried to extract useful information, such as targeted mailing lists and market performance data.

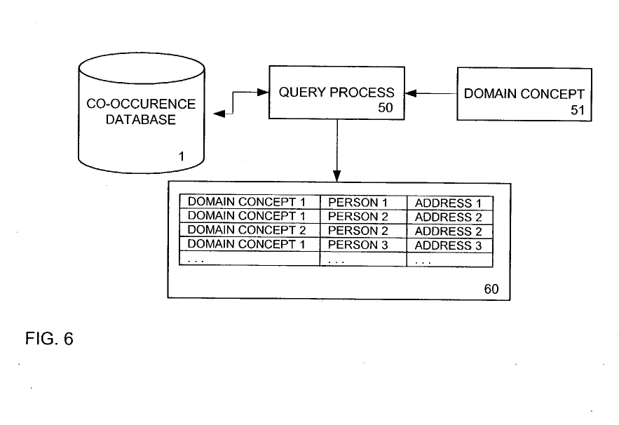

FIG. 6 illustrates an exemplary data extraction process using the Co-Occurrence Database 1 to create a targeted mailing list. As noted above, the Co-Occurrence Database is a standard relational database, therefore, the Query Process 50 simply accepts a Domain Concept 51 as input and searches the Co-Occurrence Database for the names and addresses of people who satisfy the Domain Concept's criteria. The results of this search is a mailing list 60 targeting people matching the identified criteria. For example, if it is required to identify people who are active in the area of pulmonary diseases, the query would search and filter the Co-Occurrence Database for persons whose name co-occurs in records (instances of publications) with the term ‘pulmonary diseases’. The resulting mailing list would consist of all such names together with their contact address that would be recovered from the person-address pairs of those records.

As shown in FIG. 6, one of the advantages of the method is that the query process result can associate with each person additional concepts that are found to be linked with that person. This information can then be used to create marketing materials that are further targeted to each of these additional concepts.

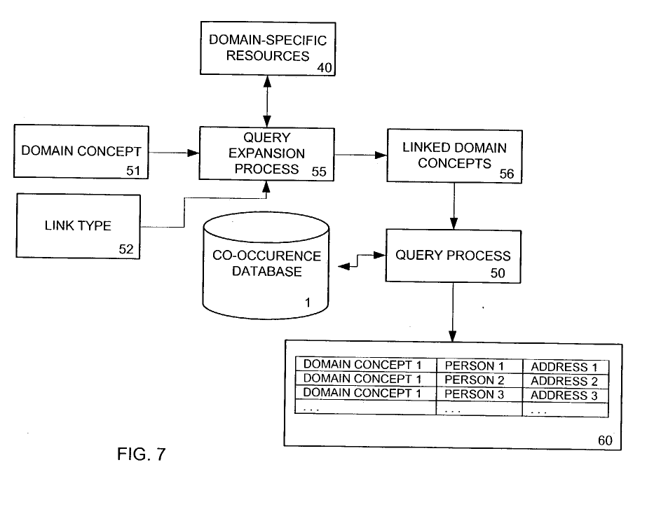

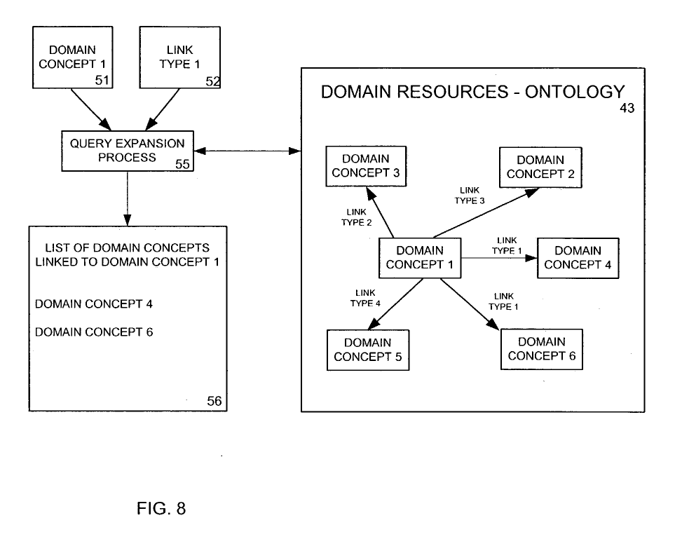

One of the advantages of maintaining taxonomies and ontologies of industry-specific concepts is that targeted mailing lists can be created not only on the basis of ‘documented concepts’ that appear directly in a publication but also on the basis of concepts that are related to the documented concepts but that do not appear in the publication. FIGS. 7 and 8 describe, in detail, this capability of the present invention, referred to as ‘query expansion.’

As can be seen in FIG. 7, the Query Expansion (QE) step essentially augments a user search criterion with concepts that are related in some way to the Domain Concept searched, thereby identifying a larger number of records that might be of interest to the user. QE works by using the Query Expansion Process 55 to replace the original user-specified Domain Concept 51 with Linked Domain Concepts 56 that contain not only the original search terms but also terms that are linked to the original terms. This is accomplished by using the conceptual links present in the Domain Specific Resources 40 to identify broader or related items.

Referring now to FIG. 7, a user specifies a Domain Concept 51 and a Link Type 52 as an input to the QE process 55. The QE process then creates a list of related concepts as an output list of Linked Domain Concepts 56 that is used to search the Co-Occurrence Database.

The QE process can work in a number of ways depending on the lexical resource being used. FIG. 7 illustrates QE with the use of an ontology, which works as follows. The user may specify a specific type of cancer e.g. colon cancer as the initial criterion for searching the Co-Occurrence Database and producing a targeted mailing list. Given this first concept, the QE process would aim to identify a list of concepts that are related to colon cancer and use this extended list to search the Co-Occurrence Database. To create the extended list the QE process 55 requests the user to specify the type of link 52 (relationship) between the initial concept and the related concepts. For example, if the user desires to consider all kinds of cancer he would specify the IS-A-KIND-OF link. Using the Ontology Domain Specific Resource 43 the QE would then identify that colon cancer is a kind of a cancer and that other kinds of cancer might be breast cancer, lung cancer and kidney cancer. In this case the original search criterion of ‘colon cancer’ would be replaced by the Linked Domain Concepts 56 containing ‘colon cancer’, ‘breast cancer’, ‘lung cancer’ and ‘kidney cancer.’ These terms would be used to search the Co-Occurrence Database. The resulting mailing list would allow the user (e.g. reagent supplier) to address a much wider customer prospect group than would be possible with the single search term. More importantly, this wider group is not a random group but one that is related to the original search criterion. The marketing materials that would be generated on the basis of this information would therefore be more targeted and would have a higher probability of converting the customer prospects into actual clients.

In another embodiment of QE, the process can be used to create better targeted materials for a single customer prospect. In this case the normal query process is first used to identify the current work, interests and purchase decisions of a single person. This is done by querying the Co-Occurrence Database for all the publications that contain the said person. Each of the returned records will also contain all other terms that have been identified by the IIP. The supplier would then have two options: (a) use the other terms and promote in his marketing material his products that are related to those terms (b) use the terms that co-appear in the returned records and for any subset of them use the lexical resources to identify other related terms and like in case ‘a’ above promote in his marketing material his products that are related to these last terms. Assume for example that a researcher X is found to use experimental procedure X, lab instrument Y and work with model organism Z in his laboratory experiments. If this researcher is already a customer of some supplier S, using that supplier's product P1 in relation to procedure X but nothing else, then S1 could create marketing material mentioning product P2 related to the use of instrument Y and product P3 related to organism Z. Furthermore using QE the supplier could identify a related procedure X′ and suggest in his marketing material product P1′ for the researcher's consideration. Because these suggestions are all based on products that are relevant to documented consumer activities and that are specific to the industry, the resulting marketing materials are expected to have a higher rate of converting prospects into customers than is possible with currently available methods.

For a more concrete example of the expansion process, assume that a taxonomy of laboratory procedures has been defined and a portion of this taxonomy contains the following information:

<class>DNA Isolation
<subclass>Purification of DNA from agarose </subclass>
<subclass>Preparation of genomic DNA from Agarose plugs</subclass>
<subclass>Bacterial Genomic DNA Isolation </subclass></class>

Further assume that a scientific article authored by Person X describes an experiment where “Preparation of genomic DNA from Agarose plugs” is performed. Assume now that a company C1 supplies a biological reagent ‘BR1’ that is well suited to “Bacterial Genomic DNA Isolation.” Using the QE process, C1 would become aware that person X has never purchased reagent ‘BR1’ and could prepare a targeted email or marketing material that would promote product BR1 to person X. “Bacterial Genomic DNA Isolation” is closely related to “Preparation of genomic DNA from Agarose plugs,” therefore, the marketing material would have a high probability of converting person X to a customer of C1.

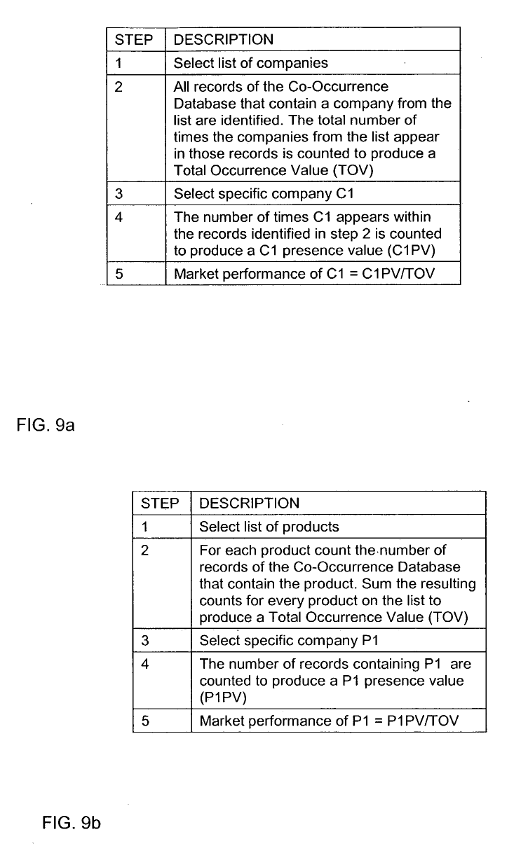

Another particularly relevant query that could be performed on the Co-Occurrence Database would generate market performance data as shown in FIGS. 9a and 9b. Market performance data can be generated both for a specific company and for a specific product of a company.

For example, as shown in FIG. 9a, the process for generating market performance data for companies consists of the following steps. (1) The end user specifies a set of companies whose performance will be assessed; for example the user could specify the names of all competitors in an industry sector, such as all the ‘laboratory supplies’ companies. (2) All records of the Co-Occurrence Database that contain companies from the list are identified and the total number of times the listed companies appear in those records is counted to produce a Total Occurrence Value (TOV). (3) A specific company ‘C1’ is selected for market performance analysis. (4) The number of times C1 appears within the records identified in step 2 is counted to produce a C1 presence value (C1PV). (5) Finally, the performance of C1 is determined to be the ratio of C1PV to TOV (C1PV/TOV). It would also be advantageous to run the above described process over time to generate a performance trend for the specified company. It might also be advantageous to run this process further limited by a domain concept, such that only records containing the identified concept are considered for the market performance analysis.

Similarly, as shown in FIG. 9b, process for generating market performance data for products consists of the following steps. (1) The end user specifies a set of products whose performance will be assessed. (2) For each product on the list the number of records that contain that product are counted. These counts for all products on the list are summed to produce a Total Occurrence Value (TOV). (3) A specific product ‘P1’ is selected for market performance analysis. (4) The number of records which contain P1 are counted to produce a P1 presence value (P1PV). (5) Finally, the performance of P1 is determined to be the ratio of P1PV to TOV (P1PV/TOV). Product performance analysis would also benefit from being run over time to generate a performance trend for the specified product or further limited by a domain concept.

In summary, the present invention describes a system and method that supports the creation of a Co-Occurrence Database, which can be used, for example, to generate targeted industry-specific mailing materials and market performance data. The present invention has benefits both for suppliers in that industry and their potential and existing customers. For suppliers (a) it creates good knowledge of who his actual customer is and what the true needs of this customer are (b) it helps avoid mass marketing approaches that are costly and have a low success rate and (c) it creates data that support fine-grained market performance analysis. For the consumer better targeted marketing materials mean not only less time wasted on processing irrelevant information but, importantly, a chance to become informed of a potentially interesting and relevant products or services, that might otherwise have escaped his attention.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact instruction and operation illustrated and described herein. Accordingly, all suitable modifications and equivalents that may be resorted to are intended to fall within the scope of the claims.

1. A method for generating industry-specific marketing materials comprising:
processing a plurality of industry-specific publications to extract industry-specific information;
creating a Co-Occurrence Database storing the extracted industry-specific information; and
generating industry-specific marketing materials by querying the Co-Occurrence Database.

2. The method according to claim 1 wherein the extracted industry-specific information comprises a researcher's name.

3. The method according to claim 2 wherein the extracted industry-specific information further comprises a researcher's address.

4. The method according to claim 1,
wherein the processing comprises identifying whether any words in the processed publications match words contained in an industry-specific key term list; and
wherein the extracted industry-specific information comprises the matched terms.

5. The method according to claim 1,
wherein the processing comprises identifying whether any words in the processed publications match words contained in an industry-specific taxonomy; and
wherein the extracted industry-specific information comprises the matched terms.

6. The method according to claim 1,
wherein the processing comprises identifying whether any words in the processed publications match words contained in an industry-specific ontology; and
wherein the extracted industry-specific information comprises the matched terms.

7. The method according to claim 1 wherein the generated marketing materials comprise a list identifying researcher names, addresses and areas of study.

8. The method according to claim 1 wherein the generated marketing materials comprise a market performance analysis showing relative market penetration.

9. The method according to claim 1 wherein the step of generating marketing materials comprises accepting a search criteria as input and using Domain Specific Resources to expand the search criteria; and wherein the expanded search criteria is used to query the Co-Occurrence Database.

10. A method for creating a Co-Occurrence Database of industry-specific materials comprising:
creating a Domain Specific Resource describing a plurality of relevant industry-specific topics;
processing a plurality of industry-specific publications to identify instances where any of the described topics appear in any of the publications;
creating a Co-Occurrence Record for each processed industry-specific publication to store a record of each identified topic described in the particular publication; and
storing each created Co-occurrence Record in the Co-Occurrence Database.

11. The method according to claim 10 wherein the process of creating the Co-Occurrence Record comprises storing each identified topic in a predefined location in the Co-Occurrence Record.

12. The method according to claim 10 wherein the Domain Specific Resource comprises a list of industry-specific topics.

13. The method according to claim 10 wherein the Domain Specific Resource comprises a taxonomy describing classes and sub-classes of industry-specific topics.

14. The method according to claim 10 wherein the Domain Specific Resource comprises an ontology describing relationships between industry-specific topics.

15. The method according to claim 10 wherein the processing of publications further comprises using formatting to determine a person identified in the publication.

16. The method according to claim 15 wherein the processing of publications further comprises using formatting to determine an address of a person identified in the publication.

17. The method according to claim 10 wherein the processing of publications further comprises using natural language processing to determine a person identified in the publication.

18. The method according to claim 17 wherein the processing of publications further comprises using natural language processing to determine an address for the person identified in the publication.

19. The method according to claim 10 wherein the processing of publications further comprises using natural language processing to determine a company identified in the publication.

20. The method according to claim 10 wherein the processing of publications further comprises using natural language processing to determine a product identified in the publication.

21. A method for generating industry-specific marketing materials comprising:
creating a Domain Specific Resource describing a plurality of relevant industry-specific topics;
processing a plurality of industry-specific publications to identify instances where any of the described topics appear in any of the publications;
creating a Co-Occurrence Record for each processed industry-specific publication to store a record of each identified topic described in the particular publication;
storing each created Co-Occurrence Record in the Co-Occurrence Database; and
generating industry-specific marketing materials by querying the Co-Occurrence Database.

22. A method for generating a targeted marketing list comprising:
accepting a Domain Concept representing one or more topics derived from Domain Specific Resources;
querying a Co-Occurrence Database to identify a relevant Co-Occurrence Record containing the Domain Concept;
identifying each person and an associated address mentioned in the relevant Co-Occurrence Record;
generating the targeted marketing list outputting a record of each identified person and their associated address.

23. The method according to claim 22, wherein the Domain Concept contains a number of broader topics generated by a Query Expansion Process; and wherein the Query Expansion process is input with a narrow topic and a link type, which it uses to search the Domain Specific Resources to find the broader topics that relate to the narrow topic as specified by the link type.

24. A method for generating market performance data comprising:
accepting a list of companies for which market analysis is required;
querying a Co-Occurrence Database to identify a TOV representing the sum of the number of times each company from the list appears in the Co-Occurrence Database; counting the number of times a specific company appears in the Co-Occurrence Database; and
reporting the TOV and the number of times the specific company appears in the Co-Occurrence Database; and reporting market performance of the specific company as the ratio of the number of times a specific company appears in the Co-Occurrence Database to the TOV

25. The method of claim 24 wherein the querying of the Co-Occurrence Database is further restricted by a Domain Concept, such that only records containing the Domain Concept are used the purpose of generating the TOV and the count of the number of times the specific company appears in the Co-Occurrence Database.

26. A method for generating market performance data comprising:
accepting a list of one or more products for which market analysis is required;
querying a Co-Occurrence Database to count for each product on the list the number of records containing the product;
generating a TOV representing the sum of the number of records counted for each product;
choosing a specific product representing one of the products on the list;
reporting the TOV and the number of records in the Co-Occurrence Database containing the specific product.

27. The method of claim 26 further comprising reporting market performance of the specific product as the ratio of the number of records in the Co-Occurrence Database containing the specific product to the TOV.

28. The method of claim 26 wherein the querying of the Co-Occurrence Database is further restricted by a Domain Concept, such that only records containing the Domain Concept are used the purpose of generating the TOV and determining the number of records containing the specific product.

29. An electronically readable medium containing data comprising a Co-Occurrence Database comprising:
a plurality of Co-Occurrence Records; and
wherein each of the Co-Occurrence Records records industry specific information derived from a Publication; the industry specific information comprising:
a Publication Title;
one or more people mentioned in the publication;
a contact address associated with each of the one or more people;
one or more domain concepts mentioned in the article.

30. The Co-Occurrence Database of claim 29 wherein the Co-Occurrence Record further comprises, a company mentioned in the Publication.

31. The Co-Occurrence Database of claim 30 wherein the Co-Occurrence Record further comprises, a product mentioned in the Publication and associated with the company.
